(19) United States
(12) Patent Application Publication
(10) Pub. No.: US 2026/0120360 A1
(43) Pub. Date: Apr. 30, 2026

(54) DIFFUSION MODEL HAVING PRUNED TEMPORAL MODULES

(71) Applicant: QUALCOMM Incorporated, San Diego, CA (US)

(72) Inventors: Amirhossein HABIBIAN, Amsterdam (NL); Amir GHODRATI, Amsterdam (NL)

(21) Appl. No.: 19/036,576

(22) Filed: Jan. 24, 2025

Related U.S. Application Data
(60) Provisional application No. 63/711,505, filed on Oct. 24, 2024.

(51) Int. Cl. G06T 11/60; G06F 3/16

(52) U.S. Cl. CPC G06T 11/60; G06F 3/16

(57) ABSTRACT

A device includes a memory configured to store media data. The device also includes one or more processors configured to obtain a media generation model. The media generation model includes a plurality of blocks that each include one or more spatial modules. A first block of the plurality of blocks includes a first count of one or more temporal modules. The first count is greater than or equal to one. A second block of the plurality of blocks includes a second count of temporal modules that is less than the first count. The one or more processors are further configured to generate, based on the media generation model, the media data.

### I. CROSS-REFERENCE TO RELATED APPLICATIONS

The present application claims priority from the commonly owned U.S. Provisional Patent Application No. 63/711,505, filed Oct. 24, 2024, entitled “DIFFUSION MODEL HAVING PTRUNED TEMPORAL MODULES,” the content of which is incorporated herein by reference in its entirety.

### II. FIELD

The present disclosure is generally related to generation of media data based on a media generation model.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

In artificial intelligence (AI), diffusion models are a class of latent variable generative models. Conventionally, diffusion models have been used in computer vision, audio, reinforcement learning, and computational biology. For example, with reference to computer vision applications, diffusion models can be used for a variety of tasks or operations, such as image denoising, inpainting, super-resolution, image generation, and video generation. As another example, in other applications, diffusion models have been applied to natural language processing task or operations, such as text generation and summarization, sound generation, and reinforcement learning. The diffusion models may have a variety of architectures, such as a U-Net architecture or a transformer architecture.

Typically, video diffusion models (e.g., generative video diffusion models) are built by adding temporal modules to an image diffusion structure (e.g., an image generation backbone). The temporal modules, such as temporal residual block (resblock) modules or temporal transformer modules, are added to model temporal correlations. The temporal modules added to the image diffusion structure to create a video diffusion model impose a significant computational cost and parameter cost to the image generation structure.

### IV. SUMMARY

According to one implementation of the present disclosure, a device includes a memory configured to store media data. The device also includes one or more processors configured to obtain a media generation model. The media generation model includes a plurality of blocks that each include one or more spatial modules. A first block of the plurality of blocks includes a first count of one or more temporal modules. The first count is greater than or equal to one. A second block of the plurality of blocks includes a second count of temporal modules that is less than the first count. The one or more processors are also configured to generate, based on the media generation model, the media data.

According to another implementation of the present disclosure, a method of operating a media device including a processor is disclosed. The method includes obtaining a media generation model. The media generation model includes a plurality of blocks that each include one or more spatial modules. A first block of the plurality of blocks includes a first count of one or more temporal modules. The first count is greater than or equal to one. A second block of the plurality of blocks includes a second count of temporal modules that is less than the first count. The method also includes generating, based on the media generation model, media data.

According to another implementation of the present disclosure, a non-transitory computer-readable medium stores instructions that are executable by one or more processors to cause the one or more processors to obtain a media generation model. The media generation model includes a plurality of blocks that each include one or more spatial modules. A first block of the plurality of blocks includes a first count of one or more temporal modules. The first count is greater than or equal to one. A second block of the plurality of blocks includes a second count of temporal modules that is less than the first count. The instructions further cause the one or more processors to generate, based on the media generation model, the media data.

According to another implementation of the present disclosure, an apparatus includes means for obtaining a media generation model. The media generation model includes a plurality of blocks that each include one or more spatial modules. A first block of the plurality of blocks includes a first count of one or more temporal modules. The first count is greater than or equal to one. A second block of the plurality of blocks includes a second count of temporal modules that is less than the first count. The apparatus also includes means for generating, based on the media generation model, media data.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of an example of a system to generate media data based on a media generation model, in accordance with one or more aspects of the present disclosure.

FIG. 2 is a block diagram to illustrate an example of a first portion of a training technique for a media generation model, in accordance with one or more aspects of the present disclosure.

FIG. 3 depicts graphs to illustrate an example of a training technique for a media generation model, in accordance with one or more aspects of the present disclosure.

FIG. 4 is a diagram of an example of training the media generation model of the system of FIG. 1, in accordance with some examples of the present disclosure.

FIG. 5 is a diagram of an example of an integrated circuit operable to generate media data based on a media generation model, in accordance with some examples of the present disclosure.

FIG. 6 is a diagram of a mobile device operable to generate media data based on a media generation model, in accordance with some examples of the present disclosure.

FIG. 7 is a diagram of a wearable electronic device operable to generate media data based on a media generation model, in accordance with some examples of the present disclosure.

FIG. 8 is a diagram of a voice-controlled speaker system operable to generate media data based on a media generation model, in accordance with some examples of the present disclosure.

FIG. 9 is a diagram of a camera operable to generate media data based on a media generation model, in accordance with some examples of the present disclosure.

FIG. 10 is a diagram of a headset, such as a virtual reality, mixed reality, or augmented reality headset, operable to generate media data based on a media generation model, in accordance with some examples of the present disclosure.

FIG. 11 is a diagram of a first example of a vehicle operable to generate media data based on a media generation model, in accordance with some examples of the present disclosure.

FIG. 12 is a diagram of a mixed reality or augmented reality glasses device operable to generate media data based on a media generation model, in accordance with some examples of the present disclosure.

FIG. 13 is a diagram of a second example of a vehicle operable to generate media data based on a media generation model, in accordance with some examples of the present disclosure.

FIG. 14 is a diagram of an example of a method of generating media data based on a media generation model, in accordance with some aspects of the present disclosure.

FIG. 15 is a diagram of an example of a method of training a media generation model, in accordance with some aspects of the present disclosure.

FIG. 16 is a block diagram of an illustrative example of a device that is operable to generate media data based on a media generation model, in accordance with one or more aspects of the present disclosure.

### VI. DETAILED DESCRIPTION

The present disclosure provides systems, apparatus, methods, and computer-readable media for generation of media data based on a media generation model, such as a diffusion model that has a U-Net architecture. Aspects disclosed herein enable use of the media generation model that includes multiple blocks and in which two or more blocks of the multiple blocks are associated with different counts of temporal modules. For example, a first block of the multiple blocks has a first count of one or more temporal modules, and a second block of the multiple blocks has a second count of temporal modules. In some embodiments, the first count is greater than or equal to one, and the second count is less than the first count. Additionally, or alternatively, each block of the multiple blocks includes one or more spatial modules. In some embodiments, each block of the multiple blocks includes the same count of spatial modules. Aspects disclosed herein also enable generation (e.g., training) of the media generation model such that one or more modules, such as a neural module (e.g., one or more temporal modules), of the media generation model are removed (e.g., pruned) during, or as a result of, training of the media generation model.

Particular implementations of the subject matter described in this disclosure can be implemented to realize one or more of the following potential advantages. In some aspects, the present disclosure provides techniques for training the media generation model in which one or more temporal modules are pruned to reduce inefficiencies, such as latency, speed, or computational overhead, as compared to a trained version of the media generation model in which the one or more temporal modules are not pruned. In some examples, the techniques for training may provide an architectural optimization process, such as a process that automatically prunes one or more neural modules from the media generation model. Additionally, or alternatively, in some other aspects, the present disclosure provides techniques for using the media generation model to efficiently generate video content. For example, the media generation model may have reduced latency or computational overhead, or increased speed as compared to the trained version of the media generation model in which the one or more temporal modules are not pruned. Accordingly, the media generation model may be used by a device, such as a low-powered device having a limited power supply (e.g., a battery), to generate media data—e.g., generative video content.

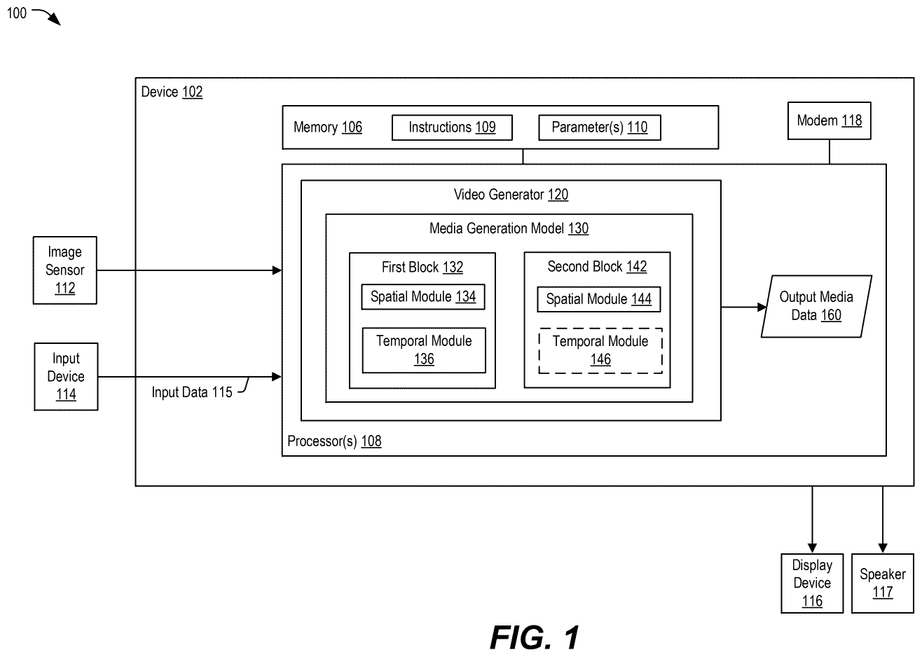

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

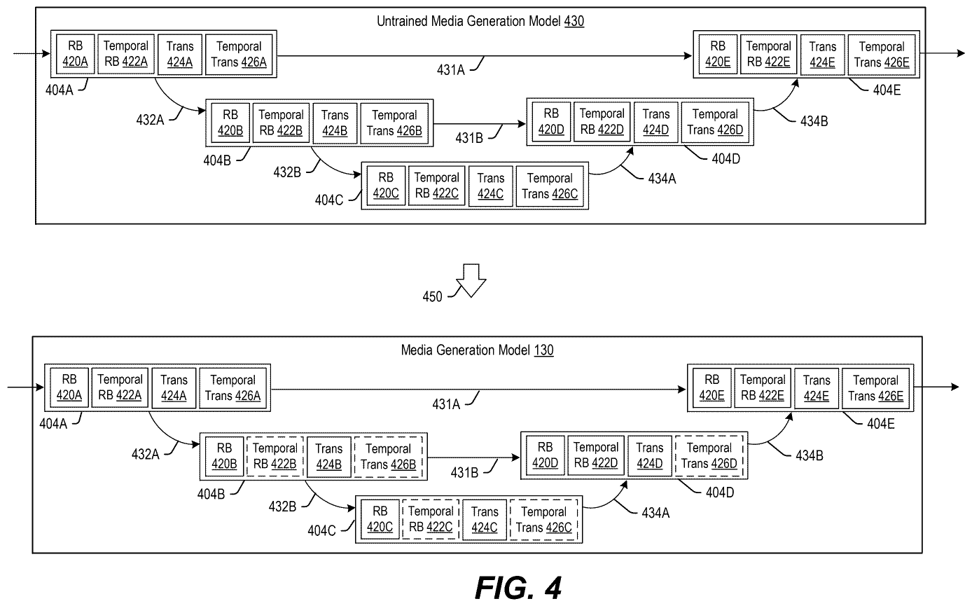

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter. For example, referring to FIG. 4, multiple blocks are illustrated and associated with reference numbers 404A, 404B, 404C, 404D, and 404E. When referring to a particular one of these blocks, such as a block 404A, the distinguishing letter “A” is used. However, when referring to any arbitrary one of these blocks or to these blocks as a group, the reference number 404 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system to generate media data based on a media generation model, in accordance with one or more aspects of the present disclosure. The system 100 includes a device 102 that is configured to or is operable to generate media data based on a media generation model 130. Additionally, or alternatively, the device 102 can be configured to or operable to train the media generation model 130.

The device 102 includes a memory 106, one or more processors 108 (collectively referred to herein as a “processor 108”), and a modem 118. The memory 106 may include one or more memories, such as a single memory or multiple different memories (of the same type or of different types).

The memory 106 is configured to store instructions 109 and one or more parameters 110 (herein after referred to as the “parameter”). In some examples, the memory 106 stores the instructions 109 that, when executed by the processor 108, cause the processor 108 to perform one or more operations as described herein. In some examples, the memory 106 stores other data, such as media data (e.g., video content) generated by the processor 108.

The parameter 110 includes low-rank adaptation (LoRA) weights associated with a model (e.g., a trained model), one or more training values to train an untrained model to generate the model, or a combination thereof. The one or more training values may include a hyperparameter (e.g., a scalar weight hyperparameter), a gate parameter (of an adaptor), an accumulation parameter, or a combination thereof. The model may include or correspond to the media generation model 130 as described further herein.

In some embodiments, the memory 106 is configured to store additional data. For example, the additional data may include or correspond to the untrained model, the model (e.g., the trained model), media content, training data, other data, or a combination thereof. The media content may include image data, audio data, video data, game data, graphics data, or a combination thereof, as illustrative, non-limiting examples.

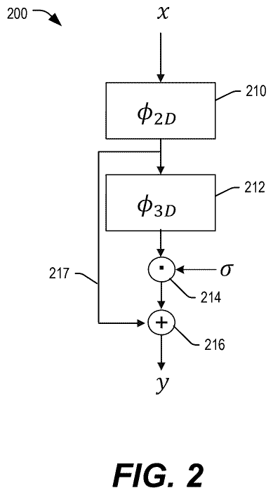

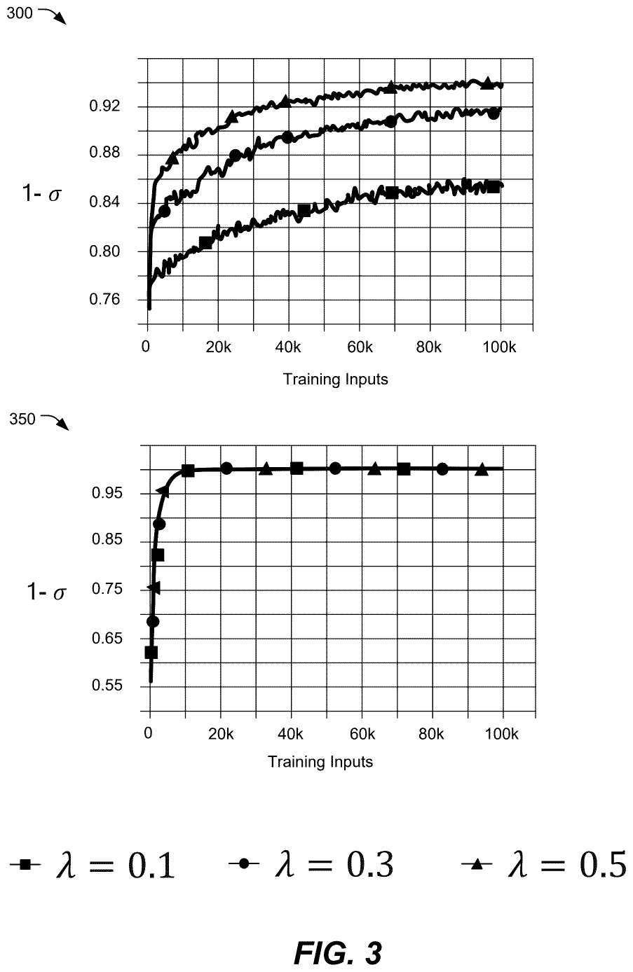

In the example illustrated in FIG. 1, the processor 108 includes a video generator 120. The video generator 120, or portions thereof, may be implemented by the processor 108 executing the instructions 109 (e.g., software), dedicated hardware (e.g., circuitry), a combination thereof. The video generator 120 is configured to perform one or more video generation operations associated with generation of video content. In some examples, the video generator 120 is configured to use the media generation model 130 to perform the one or more video generation operations. To illustrate, the video generator 120 may perform one or more operations, in association with the media generation model 130, to generate output media data 160, such as video data as an illustrative, non-limiting example. The one or more video generation operations may include or correspond to a denoising operation, text-based video content generation, text-based video content editing, video enhancement (e.g., super-resolution, colorization, etc.), video compression, or data augmentation for model training and evaluation, as illustrative, non-limiting examples. In some embodiments, the video generator 120 is configured to obtain the media generation model 130. For example, to obtain the media generation model 130, the processor 108 (e.g., the video generator 120) may receive or retrieve the media generation model 130 from a memory, such as the memory 106. As another example, to obtain the media generation model 130, the processor 108 (e.g., the video generator 120) may generate the media generation model 130, such as by training an untrained media generation model to generate the media generation model 130, as described further herein at least with reference to FIGS. 2 and 3.

The video generator 120 is optional and is omitted in some embodiments. For example, when the media generation model 130 is configured to generate spatial audio data, the video generator 120 can be replaced with an audio generator. As another example, when the media generation model 130 is configured to generate game data, the video generator 120 can be replaced with a game display generator. In other examples, the video generator 120 can be replaced with a media generator that is configured to generate media data, such as image data, audio data, video data, game data, graphics data, or a combination thereof, as illustrative, non-limiting examples.

The media generation model 130 includes multiple blocks. Each block of the multiple blocks includes one or more spatial modules, one or more temporal modules, or a combination thereof. Additionally, or alternatively, each block of the multiple blocks is configured to perform one or more operations, such as one or more convolutions. In some embodiments, the media generation model 130 has a U-Net architecture that includes the multiple blocks, as described further herein at least with reference to FIG. 4. When the media generation model 130 has the U-Net architecture, the multiple blocks may include one or more encoder blocks, a bridge block, one or more decoder blocks, or a combination thereof. Additionally, or alternatively, the media generation model 130 includes a diffusion model, such as a latent diffusion model (LDM). In a particular embodiment, the media generation model 130 includes a generative model, such as a video diffusion model. The media generation model 130 may be generated (e.g., trained) in a latent space. Accordingly, the media generation model 130 may be configured to perform image synthesis (e.g., image processing) with a relatively low computational demand as compared to image synthesis performed in a pixel space.

In some embodiments, the multiple blocks include the first block 132 and the second block 142. Although the media generation model 130 is described as including two blocks, in other implementations, the media generation model 130 may include more than two blocks, such as five blocks, fifteen blocks, twenty blocks, or another number of blocks.

In some embodiments, each block of the multiple blocks includes one or more spatial modules. For example, the first block 132 includes a spatial module 134 and the second block 142 includes a spatial module 144. In some embodiments, each block of the multiple blocks (of the media generation model 130) includes the same count of spatial modules. To illustrate, in such embodiments, if the first block 132 includes four spatial modules 134, then the second block 142 also includes four spatial modules 144. More generally, if the first block 132 includes X spatial modules 134 (where X is an integer greater than or equal to one), then the second block 142 also includes X spatial modules 144. Each of the one or more spatial modules includes a residual block (resblock) module, a transformer module, or a combination thereof.

Additionally, or alternatively, each block of the multiple blocks is associated with a respective count of temporal modules. For example, the first block 132 of the multiple blocks includes a first count of temporal modules 136, and the second block 142 includes a second count of temporal modules 146. The count of temporal modules of a block of the multiple blocks (of the media generation model 130) may include zero, one, two, or more than two. In some examples, the first count may be greater than or equal to one, and the second count may be less than the first count. Accordingly, the first block 132 may include one or more temporal modules, such as a representative temporal module 136, and the second block 142 may optionally (as indicated by a dashed box) include one or more temporal modules, such as a representative temporal module 146. As a particular illustrative embodiment, the first block 132 includes one or more temporal modules (e.g., the temporal module 136), and the second block includes zero temporal modules. As another particular example, the first block 132 includes two or more temporal modules, and the second block 142 includes a single temporal module. More generally, the first block 132 includes M temporal modules 136 (where M is an integer greater than or equal to zero), and the second block 142 includes N temporal modules 146 (where N is an integer greater than or equal to zero, and M is not equal to N). A temporal module of the media generation model 130 may include a temporal resblock module, a temporal transformer module, or a combination thereof, as illustrative non-limiting examples.

The modem 118 is coupled to the processor 108 and is configured to transmit video content (e.g., the output media data 160) to a second device for output by the second device. Additionally, or alternatively, the modem 118 is configured to transmit the media generation model 130 to the second device. In some embodiments, the modem 118 may be configured to receive data from another device. For example, the data received by the modem 118 may include model data (e.g., an untrained model, an unpruned model, or the media generation model 130), the parameter 110, media data (e.g., image data, video data, or audio data), an input, or a combination thereof.

In the example illustrated in FIG. 1, the processor 108 is also coupled to an image sensor 112, an input device 114 (e.g., a microphone, a keyboard or touch screen, etc.), a display device 116, and a speaker 117. The image sensor 112 may include one or more cameras and may be configured to generate input media data. Video content, such as the output media data 160, may be generated by the processor 108 at least partially based on the input media data. The input device 114 is configured to receive an input and provide the input to the processor 108 as input data 115. For example, the input device 114 may include a keyboard, a touch screen, or a microphone configured to receive the input and provide the input data 115 (e.g., an input signal) to the processor 108. In some embodiments, the input may be received based on or in association with a prompt. The input (e.g., the input data 115) may include or indicate a request to generate output video content, such as a request to generate the output media data 160 based on the media generation model 130 and the input media data. In some examples, the input includes a request to perform a text-based video generation, a text-based video content editing operation, a video enhancement operation, video compression, a data augmentation operation, or a combination thereof. Additionally, or alternatively, the input includes or indicates a quality indicator associated with the output media data 160. Based on the quality indicator, the processor 108 (e.g., the video generator 120) can select a set of low-rank adaptation (LoRA) weights from multiple sets of LoRA weights and apply the LoRA weights to the media generation model 130.

The display device 116 is coupled to the processor 108 and is configured to output the output media data 160 generated based on the input media data. In some examples, the display device 116 includes a display screen, a monitor or television, a projector, or a combination thereof. In some embodiments, the device 102 (e.g., the processor 108) is configured to output audio associated with the output media data 160 (e.g., video content) generated based on the input media data.

The image sensor 112, the input device 114, the display device 116, the speaker 117, or a combination thereof, may be coupled to or integrated within the device 102. Although the device 102 is described as being coupled to or including the image sensor 112, the input device 114, the display device 116, the speaker 117, and the modem 118, in other implementations the device 102 may not include or be coupled to the image sensor 112, the input device 114, the display device 116, the speaker 117, the modem 118, or a combination thereof.

In some embodiments, the device 102 (e.g., the processor 108) is configured to generate (e.g., train) the media generation model 130. Referring to FIGS. 2-4, illustrative examples of training techniques for generation of the media generation model are disclosed. For example, FIG. 2 is a block diagram to illustrate an example of a training technique for the media generation model 130, in accordance with one or more aspects of the present disclosure. FIG. 3 depicts graphs to illustrate an example of the training technique for the media generation model 130, in accordance with one or more aspects of the present disclosure. FIG. 4 is a diagram of an example of training the media generation model 130 of the system of FIG. 1, in accordance with some examples of the present disclosure.

Referring to FIG. 2A, a training architecture 200 associated with an untrained media generation model is established. For example, the processor 108 may generate the training architecture 200. The untrained media generation model may be trained to generate the media generation model 130. The training architecture 200 includes one or more spatial modules 210 (hereinafter referred to as the “spatial module 210”), one or more temporal modules 212 (hereinafter referred to as the “temporal module 212”), a multiplier 214 (e.g., a gate), and a combiner 216. The spatial module 210 and the temporal module 212 may include or correspond to portions (e.g., a block or a portion of a block) of the untrained media generation model. For example, the untrained media generation model may be an initial version (e.g., an untrained version) of the media generation model 130. An example of the untrained media generation model is described further herein at least with reference to FIG. 4.

In some embodiments, the spatial module 210 includes or is initialized based on a pre-trained 2D model that includes a 2D resnet module, a 2D transformer, or a combination thereof. For example, the pre-trained 2D model may be an image model, such as an image generation model, that has been trained based on multiple images—e.g., multiple high-quality images. The output of the spatial module 210 is provided to the temporal module 212. Additionally, the training architecture 200 includes a residual adapter structure in which the output of the spatial module 210 is provided to the combiner 216 via a skip connection 217 such that, for a zero output of the temporal module 212 (when training is started), the combiner 216 outputs the same output as the spatial module 210.

The multiplier 214 is configured to operate as a gate and multiply the output of the temporal module 212 and a gating function o (also referred to as a learnable gating function). It is noted that a different gating function o may be provided for each temporal module of the one or more temporal modules 212. The gating function o may be:

$$σ = sigmoid ( \frac{θ}{τ} ) ,$$

where sigmoid is a sigmoid function, θ is a gate parameter (e.g., a scalar parameter), and τ is a temperature parameter. In some examples, τ is a parameter, such as τ=0.1. Accordingly, the training architecture 200 has a residual adaptor structure in which:

$${z}_{2 D} = {ϕ}_{2 D} ( x )$$

$$y = {z}_{2 D} + σ {ϕ}_{3 D} ( {z}_{2 D} )$$

where x is input training data (e.g., image data), φ_{2D} is a spatial module (e.g., 210), z_{2D} is an output of φ_{2D}, φ_{3D} is a temporal module (e.g., 212), and y is training output data.

In some examples, it is noted that the gate parameter θ may be a single parameter which is learned. The gate parameter θ may be initialized with high values so that the gate is active at the beginning of the training. The gate being active at the start of training may ensure that the model generates a valid output (per-frame) and that the model gradually generates consistent videos by learning parameters of the temporal module 212. If the gate parameter θ is zero (or approximately zero), an output of a corresponding temporal module 212 is zeroed out (or effectively zeroed out) and the corresponding temporal module 212 can be removed from the media generation model 130.

In some embodiments, the training architecture 200 includes a parametric gate (e.g., an average gate) that is applied to the output of the temporal module 212. For example, the parametric gate may be added as a regularizer to a loss function £ during training. The loss function [symbol] may be:

$$ℒ = {ℒ}_{diffusion} + λ {{\sum }_{ℓ = 1}}^{L} {σ}^{ℓ}$$

where [symbol] _{diffusion} is a diffusion loss function, A is a scalar weight hyperparameter, and [symbol] is a number of training inputs (e.g., training operations associated with different inputs of x). A value of the scalar weight hyperparameter 1 may be associated with a trade-off between quality of an output generated by the model versus efficiency of the model. For example, the higher the value of the scalar weight hyperparameter A is, the more pruning occurs and the quality of an output of the model may decrease while the efficiency of the model increases.

During training, the processor 108 may initialize (e.g., provide input to) the spatial module 210 and provide an output of the spatial module 210 to the temporal module 212. An output of the temporal module 212 is multiplied (at the multiplier 214) to gating function σ having the gate parameter θ. The gate function σ may be initialized to a first value for the start of the training. In some embodiments, initializing the training architecture 200 may include selecting a value of the scalar weight hyperparameter λ. Output of the multiplier 214 is combined with the output of the spatial module 210 at the combiner 216 to generate output data y.

The processor 108 may use the training data x to train the untrained media generation model and thereby generate the media generation model 130. During training, the gate parameter θ may be adapted (e.g., learned). For example, the gate parameter θ may be adapted based on the loss function [symbol] associated with the media generation model 130. The loss function [symbol] includes a term based on an average gate parameter value, such as

$${\sum }_{ℓ = 1}^{L} {σ}^{ℓ} ,$$

associated with the media generation model 130.

After adapting the gate parameters θ of multiple blocks of the untrained media generation model to generate an unpruned version of the media generation model 130, the processor 108 may prune (e.g., remove) temporal modules (e.g., the temporal module 212) from various blocks of the unpruned version of the media generation model 130 based on a value of the learned gate parameter θ associated with the temporal module 212. For example, in a model that includes multiple blocks, each of which includes one or more temporal modules, certain of the temporal modules, can be pruned (e.g., removed) without significantly negatively impacting the quality of media output of the resulting media generation model 130. Since the temporal modules are computationally expensive and use significant memory resources, pruning the model to remove such temporal modules can provide significant benefits, such as providing a model that can be used more efficiently and that has a smaller memory footprint.

In some implementations, different instances of the media generation model 130 can be trained for different values of the scalar weight hyperparameter A. In some embodiments, one media generation model 130 may be generated based on the training. In some such embodiments, multiple sets of LoRA weights can be generated for the one media generation model 130, where each set of LoRA weights of the multiple sets of LoRA weights corresponds to a different value of the scalar weight hyperparameter λ.

FIG. 3 includes graphs associated with training different temporal modules (e.g., 212) using different values of the scalar weight hyperparameter λ. To illustrate, the different values of the scalar weight hyperparameter λ are 0.1, 0.3, and 0.5, as illustrative, non-limiting examples. For example, the graphs include a first graph 300 and a second graph. Each of the graphs illustrate a count of training inputs (e.g., x) along the x-axis, and 1−θ (e.g., the gate parameter θ associated with the corresponding temporal module) along the y-axis. When the value of 1−θ approaches 1 (i.e., the gate parameter θ approaches zero), the corresponding temporal module may be identified to be removed (e.g., pruned). For example, the first graph 300 indicates that the temporal module corresponding to the first graph 300 should not be pruned for any of the different values of the scalar weight hyperparameter λ. As another example, the second graph 350 indicates that the temporal module corresponding to the second graph 350 should be pruned (e.g., removed) for each of the different values of the scalar weight hyperparameter λ.

FIG. 4 shows the untrained media generation model 430 that is trained to generate the media generation model 130. The untrained media generation model 430 is initialized by the processor 108. In some embodiments, to initialize the untrained media generation model 430, the processor may start with a pre-trained 2D model that includes a 2D resnet module, a 2D transformer, or a combination, and add one or more untrained 3D modules, such as one or more temporal modules. The processor 108 may perform a training process, which may include pruning, as indicated by an arrow 450. The training process may include or correspond to the training technique described with reference to at least FIGS. 2 and 3.

The untrained media generation model 430 may have a U-Net architecture or another architecture. The U-Net architecture is a type of convolution neural network (CNN). The untrained media generation model 430 can include multiple blocks 404. For example, the multiple blocks 404 may include a first block 404A, a second block 404B, a third block 404C, a fourth block 404D, and a fifth block 404E. Although the untrained media generation model 430 is described as including five blocks, in other examples, the untrained media generation model 430 can include fewer or more than five blocks. The untrained media generation model 430 may be arranged in multiple layers, such as a first layer that includes the first block 404A and the fifth block 404E, a second layer that includes the second block 404B and the fourth block 404D, and a third layer that includes the third block 404C.

The U-Net architecture may also be configured to concatenate feature maps from a downsampling path with feature maps from an upsampling path. To illustrate, feature maps output from the first block 404A are downsampled via a first downsample path 432A and provided to the second block 404B, and feature maps output from the second block 404B are downsampled via a second downsample path 432B and provided to the third block 404C. The first block 404A, the first downsample path 432A, the second block 404B, and the second downsample path 432B may correspond to an encoder end (e.g., an encoder portion) of the untrained media generation model 430. The third block 404C (e.g., the third layer) may be associated with a bottleneck (e.g., a bottleneck portion) of the untrained media generation model 430.

Feature maps output from the third block 404C are upsampled via a first upsample path 434A and provided to the fourth block 404D, and feature maps output from the fourth block 404D are upsampled via a second upsample path 434B and provided to the fifth block 404E. The first upsample path 434A, the fourth block 404D, the second upsample path 434B, and the fifth block 404E may correspond to a decoder end (e.g., a decoder portion) of the untrained media generation model 430.

Additionally, the feature maps output by the first block 404A are provided via a first connecting path 431A to the fifth block 404E and concatenated with the feature maps that are received by the fifth block 404E from the fourth block 404D. The feature maps output by the second block 404B are provided via a second connecting path 431B to the fourth block 404D and concatenated with the feature maps that are received by the fourth block 404D from the third block 404C.

Each block of the multiple blocks 404 of the untrained media generation model 430 includes one or more spatial modules and one or more temporal modules. In some examples, the one or more spatial modules may include a residual block (resblock) module 420 (also referred to as a resblock layer), a transformer module 424 (also referred to as a transformer layer), or a combination thereof. Additionally, or alternatively, the one or more temporal modules may include a temporal resblock module 422 (also referred to as a temporal resblock layer), a temporal transformer module 426 (also referred to as a temporal transformer layer), or a combination thereof. Each block of the multiple blocks 404 of the untrained media generation model 430 may have the same number of spatial modules, the same number of temporal modules, or a combination thereof. In other examples, a first block of the multiple blocks 404 of the untrained media generation model 430 includes a different number of spatial modules, a different number of temporal modules, or both, as compared to a second block of the multiple blocks 404 of the untrained media generation model 430.

In the example of the untrained media generation model 430 depicted in FIG. 4, the first block 404A includes a resblock module 420A, a temporal resblock module 422A, a transformer module 424A, and a temporal transformer module 426A. The second block 404B of the untrained media generation model 430 includes a resblock module 420B, a temporal resblock module 422B, a transformer module 424B, and a temporal transformer module 426B. The third block 404C of the untrained media generation model 430 includes a resblock module 420C, a temporal resblock module 422C, a transformer module 424C, and a temporal transformer module 426C. The fourth block 404D of the untrained media generation model 430 includes a resblock module 420D, a temporal resblock module 422D, a transformer module 424D, and a temporal transformer module 426D. The fifth block 404E of the untrained media generation model 430 includes a resblock module 420E, a temporal resblock module 422E, a transformer module 424E, and a temporal transformer module 426E.

In some embodiments, the resblock module 420, the temporal resblock module 422, or a combination thereof, is configured to perform an upsampling operation (that increases a resolution), a downsampling operation (that lowers a resolution), another operation, or a combination thereof.

The untrained media generation model 430 can be trained and pruned (as indicated by an arrow 450) to remove one or more temporal modules to generate the media generation model 130. For example, the training and pruning may be performed as described herein at least with reference to FIG. 2. In the example of the media generation model 130 shown in FIG. 4, the temporal resblock module 422B, the temporal transformer module 426B, the temporal resblock module 422C, the temporal transformer module 426C, and the temporal transformer module 426D may be pruned (as indicated by the dashed boxes). It is noted that the pruned temporal modules are illustrative and different temporal modules may be pruned.

Referring back to FIG. 1, during operation of the system 100, the processor 108 (e.g., the video generator 120) obtains the media generation model 130. For example, the processor 108 may obtain the media generation model 130 from the memory 106, from or via the modem 118, from or via an interface of the device 102, or a combination thereof. In some other examples, to obtain the media generation model 130, the processor 108 may generate (e.g., train) the media generation model 130.

The processor 108 (e.g., the video generator 120) may generate, based on the media generation model 130, the output media data 160. As part of generation of the output media data 160, the processor 108 (e.g., the video generator 120) may perform a text-based video generation operation, a text-based video content editing operation, a video enhancement operation, video compression, a data augmentation operation, or a combination thereof. In some examples, the processor 108 (e.g., the video generator 120) may apply the media generation model 130 to perform the text-based video generation operation, the text-based video content editing operation, the video enhancement operation, the video compression, the data augmentation operation, or a combination thereof.

In some embodiments, the processor 108 determines or receives a quality indicator associated with the media data. For example, the processor 108 may select, based on the quality indicator, a set of LoRA weights from multiple sets of LoRA weights (e.g., the parameter 110). Additionally, or alternatively, the processor 108 (e.g., the video generator 120) may apply the selected set of LoRA weights to the media generation model 130 for generation of the output media data 160.

In some embodiments, the output media data 160 can be stored at the memory 106. Additionally, or alternatively, the modem 118 can receive the output media data 160 from the processor 108 or the memory 106 and transmit the output media data 160 to a second device for output by the second device.

In some embodiments, the image sensor 112 is configured to generate image data, such as input media data. The image sensor 112 may send the image data to the processor 108 and the processor (e.g., the video generator 120) generates the output media data 160 at least partially based on the image data. Additionally, or alternatively, the input device 114 may receive an input and provide the input to the processors 108 as the input data 115. The input includes a request (e.g., a user command) to generate the output media data 160. For example, the request may include a request to generate the output media data 160 based on image data from the image sensor 112. In some embodiments, the input device 114 includes a microphone.

In some embodiments, the display device 116 outputs the output media data 160 (e.g., the video content). Additionally, or alternatively, the speaker 117 outputs audio (e.g., output audio) associated with the media data.

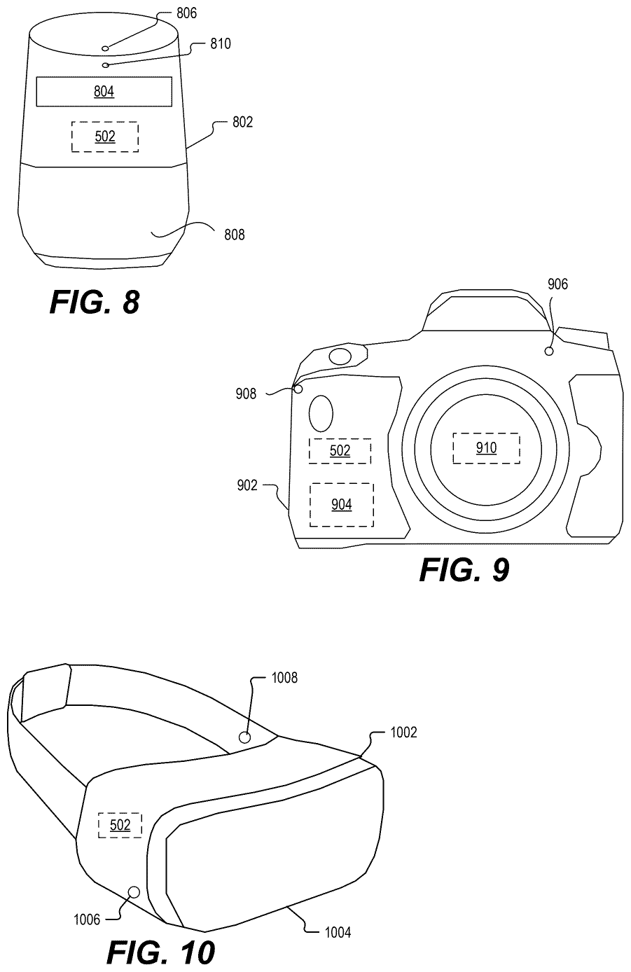

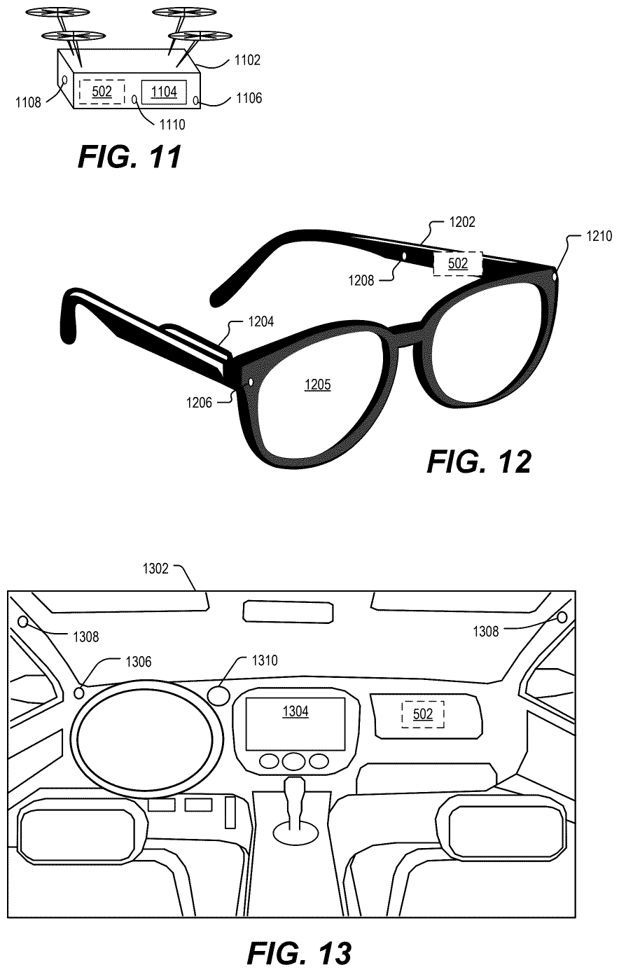

In some examples, the device 102 corresponds to or is included in one of various types of devices, such that the processor 108 can be integrated in multiple types of devices. In an illustrative example, the processor 108 is integrated in a wearable device, such as a wearable electronic device as depicted in FIG. 7, a virtual reality, mixed reality, or augmented reality headset as depicted in FIG. 10, a mixed reality or augmented reality glasses device as described with reference to FIG. 12, or another wearable device. In another illustrative example, the processor 108 is integrated in a mobile device (a mobile phone or a tablet) as depicted in FIG. 6, a voice-controlled speaker system as depicted in FIG. 8, a camera as depicted in FIG. 9, a vehicle as depicted in FIG. 11 or FIG. 13, a computer or a server, an edge device, or another system or device.

One technical advantage of implementing the device 102 as described above is that the media generation model 130 is trained such that one or more temporal modules are pruned to reduce inefficiencies, such as latency, speed, or computational overhead, as compared to a trained version of the media generation model in which the one or more temporal modules are not pruned. Additionally, or alternatively, the device 102 may advantageously use the media generation model 130 to efficiently generate the output media data 160 (e.g., video content). For example, the media generation model 130 may have reduced latency or computational overhead, or increased speed as compared to the trained version of the media generation model in which the one or more temporal modules are not pruned. Accordingly, the media generation model 130 may be used by the device 102, such as a low-powered device having a limited power supply (e.g., a battery), to generate the output media data 160—e.g., generative video content.

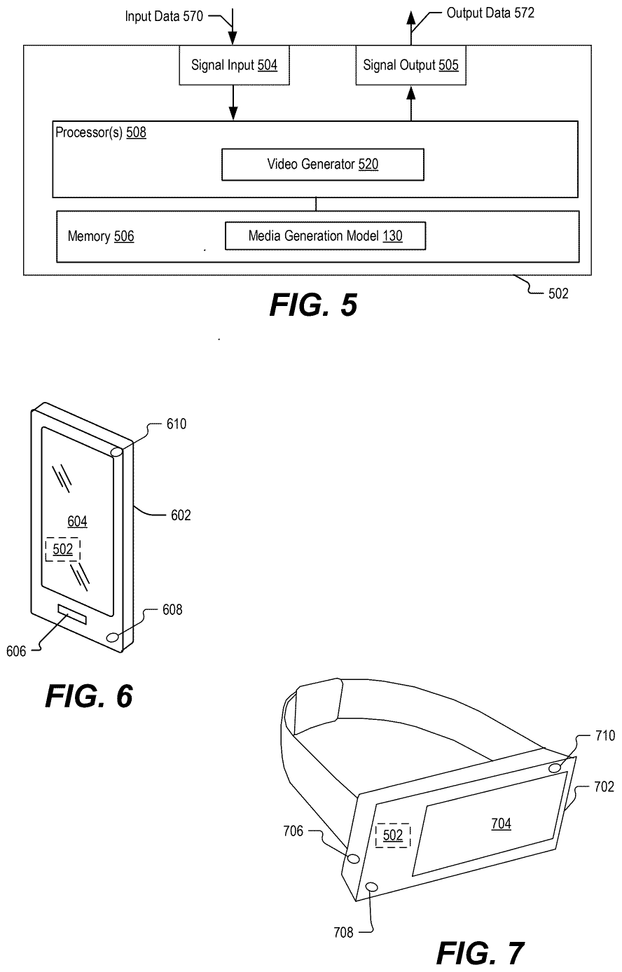

FIG. 5 depicts a diagram of an example of an integrated circuit 502 operable to generate media data based on a media generation model, in accordance with some examples of the present disclosure. The integrated circuit 502 includes one or more processors 508 (herein after referred to as the “processor 508”) and a memory 506. The processor 508 and the memory 506 may include or correspond to the processor 108 and the memory 106, respectively. The processor 508 may include the video generator 520. The video generator 520 may include or correspond to the video generator 120. The memory 506 includes (e.g., stores) the media generation model 130.

The integrated circuit 502 also includes a signal input 504, such as one or more bus interfaces, to enable the integrated circuit 502 to receive signals representing input data 570 for processing. For example, the input data 570 can correspond to media data, such as image data, audio data, video data, game data, graphics data, or a combination thereof, as illustrative, non-limiting examples.

The integrated circuit 502 also includes a signal output 505, such as a bus interface, to enable the integrated circuit 502 to output signals representing output data 572. For example, the output data 572 can correspond to or include the output media data 160, the media generation model 130, or a combination thereof.

The integrated circuit 502 including the video generator 520 and the media generation model 130 enables implementation of video generation in a system or a device. For example, the system or the device may include a mobile device (e.g., a mobile phone or tablet) as depicted in FIG. 6, a wearable electronic device as depicted in FIG. 7, a voice-controlled speaker system as depicted in FIG. 8, a camera device as depicted in FIG. 9, a virtual reality, mixed reality, or augmented reality headset as depicted in FIG. 10, a mixed reality or augmented reality glasses device, as described with reference to FIG. 12, or a vehicle as depicted in FIG. 11 or FIG. 13.

In some implementations, the system or the device that includes the integrated circuit 502 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 112, the input device 114, the display device 116, the speaker 117, and the modem 118, respectively.

FIG. 6 depicts a diagram of a mobile device 602 operable to generate media data based on a media generation model, in accordance with some examples of the present disclosure. The mobile device 602 may include or correspond to a phone or a tablet, as illustrative, non-limiting examples. The mobile device 602 includes a display 604 (e.g., a display screen), a microphone 606, a speaker 608, a camera 610 (e.g., an image sensor), and the integrated circuit 502. Components of the integrated circuit 502, including the video generator 520 and the media generation model 130, are integrated in the mobile device 602 and are illustrated using dashed lines to indicate internal components that are not generally visible to a user of the mobile device 602.

FIG. 7 depicts a diagram of a wearable electronic device 702 operable to generate media data based on a media generation model, in accordance with some examples of the present disclosure. The wearable electronic device 702 may include or correspond to a “smart watch,” as an illustrative, non-limiting example. The wearable electronic device 702 includes a display 704 (e.g., a display screen), a microphone 706, a speaker 708, a camera 710 (e.g., an image sensor), and the integrated circuit 502. Components of the integrated circuit 502, including the video generator 520 and the media generation model 130, are integrated in the wearable electronic device 702 and are illustrated using dashed lines to indicate internal components that are not generally visible to a user of the wearable electronic device 702.

FIG. 8 is a diagram of a voice-controlled speaker system 802 operable to generate media data based on a media generation model, in accordance with some examples of the present disclosure. The voice-controlled speaker system 802 may include or correspond to a wireless speaker and voice activated device, as an illustrative, non-limiting example. The voice-controlled speaker system 802 can have wireless network connectivity and is configured to execute an assistant operation. The wireless speaker and voice activated device 802 includes a display 804 (e.g., a display screen), a microphone 806, a speaker 808, a camera 810 (e.g., an image sensor), and the integrated circuit 502. Components of the integrated circuit 502, including the video generator 520 and the media generation model 130, are integrated in the voice-controlled speaker system 802 and are illustrated using dashed lines to indicate internal components that are not generally visible to a user of the voice-controlled speaker system 802.

FIG. 9 is a diagram of a camera device 902 operable to generate media data based on a media generation model, in accordance with some examples of the present disclosure. The camera device 902 includes a display 904 (e.g., a display screen), a microphone 906, a speaker 908, an image sensor 910, and the integrated circuit 502. Components of the integrated circuit 502, including the video generator 520 and the media generation model 130, are integrated in the camera device 902 and are illustrated using dashed lines to indicate internal components that are not generally visible to a user of the camera device 902.

FIG. 10 is a diagram of a headset 1002, such as a virtual reality, mixed reality, or augmented reality headset, operable to generate media data based on a media generation model, in accordance with some examples of the present disclosure. A visual interface device is positioned in front of the user's eyes to enable display of augmented reality, mixed reality, or virtual reality images or scenes to the user while the headset 1002 is worn. The headset 1002 also includes a display 1004 (e.g., a display screen), a microphone 1006, a speaker 1008, and the integrated circuit 502. Components of the integrated circuit 502, including the video generator 520 and the media generation model 130, are integrated in the headset 1002 and are illustrated using dashed lines to indicate internal components that are not generally visible to a user of the headset 1002.

FIG. 11 is a diagram of a first example of a vehicle 1102 operable to generate media data based on a media generation model, in accordance with some examples of the present disclosure. The vehicle 1102 may include or correspond to a manned or unmanned aerial device (e.g., a package delivery drone). The vehicle 1102 includes a display 1104 (e.g., a display screen), a microphone 1106, a speaker 1108, a camera 1110 (e.g., an image sensor), and the integrated circuit 502. Components of the integrated circuit 502, including the video generator 520 and the media generation model 130, are integrated in the vehicle 1102 and are illustrated using dashed lines to indicate internal components that are not generally visible to a user of the vehicle 1102.

FIG. 12 is a diagram of a mixed reality or augmented reality glasses device 1202 operable to generate media data based on a media generation model, in accordance with some examples of the present disclosure. The glasses 1202 include a holographic projection unit 1204 configured to project visual data onto a surface of a lens 1205 or to reflect the visual data off of a surface of the lens 1205 and onto the wearer's retina. The glasses 1202 also include a microphone 1206, a speaker 1208, a camera 1210 (e.g., an image sensor), and the integrated circuit 502. Components of the integrated circuit 502, including the video generator 520 and the media generation model 130, are integrated in the glasses 1202 and are illustrated using dashed lines to indicate internal components that are not generally visible to a user of the glasses 1202.

FIG. 13 is a diagram of a second example of a vehicle 1302 operable to generate media data based on a media generation model, in accordance with some examples of the present disclosure. The vehicle 1302 may include or correspond to a car. The vehicle 1302 includes a display 1304 (e.g., a display screen), a microphone 1306, one or more speakers 1308, a camera 1310 (e.g., an image sensor), and the integrated circuit 502. Components of the integrated circuit 502, including the video generator 520 and the media generation model 130, are integrated in the vehicle 1302 and are illustrated using dashed lines to indicate internal components that are not generally visible to a user of the vehicle 1302.

The embodiments of the systems or devices as described with reference to FIGS. 6-13 are described, respectively, as including a display, a microphone, a speaker, a camera, or a combination thereof. As described with reference to FIGS. 6-13, the display, the microphone, the speaker, the camera may include or correspond to the display device 116, the input device 114, the speaker 117, and the image sensor 112, respectively. It is noted that in other embodiments of the systems or devices of FIGS. 6-13, one or more of the systems or devices of FIGS. 6-13 may not include the display, the microphone, the speaker, the camera, or a combination thereof. Additionally, or alternatively, one or more of the systems or devices of FIGS. 6-13 may include an additional component. For example, the additional component may include a modem, such as the modem 118.

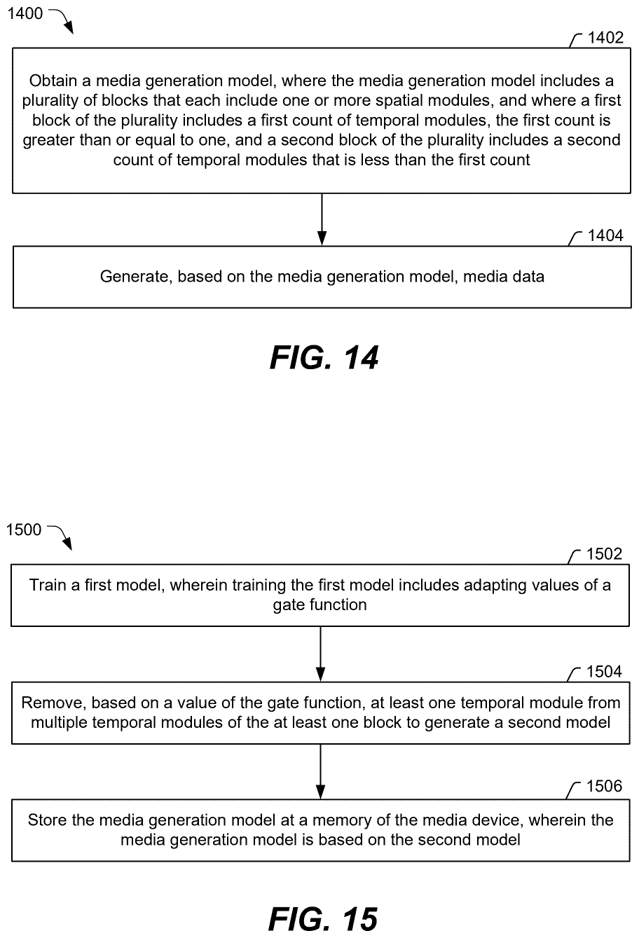

FIG. 14 is a diagram of an example of a method 1400 of generating media data based on a media generation model, in accordance with some aspects of the present disclosure. In a particular aspect, one or more operations of the method 1400 are performed by the system 100, the device 102, the processor 108, the video generator 120, or a combination thereof.

In some embodiments, the method 1400 includes, at block 1402, obtaining a media generation model. For example, the media generation model may include or correspond to the media generation model 130. The media generation model includes a plurality of blocks that each include one or more spatial modules. The plurality of blocks may include the first block 132, the second block 142, the block 404, or a combination thereof. Additionally, the one or more spatial modules include or correspond to the spatial module 134 or 144, the resblock module 420, the transformer module 424, or a combination thereof. A first block of the plurality includes a first count of temporal modules. For example, the first block 132 of FIG. 1 may include the temporal module 136. The first count is greater than or equal to one. A second block of the plurality includes a second count of temporal modules that is less than the first count. For example, the second block 142 of FIG. 1 may or may not include the temporal module 146.

In some examples, the media generation model has a U-Net architecture including the plurality of blocks. The one or more spatial modules may include a residual block (resblock) module, a transformer module, or a combination thereof. The res module and the transformer module may include or correspond to the resblock module 420 and the transformer module 424, respectively. In some examples, each block of the plurality of blocks includes the same count of spatial modules. Additionally, or alternatively, the one or more temporal modules of the first block include a temporal residual block (resblock) module, a temporal transformer module, or a combination thereof. The temporal resblock and the temporal transformer module may include or correspond to the temporal resblock module 422 and the temporal transformer module 426, respectively. In some embodiments, one or more blocks of the plurality of blocks include a count of zero temporal modules.

The method 1400 also includes, at block 1404, generating, based on the media generation model, media data. The media data may include or correspond to the output media data 160.

In some embodiments, the media generation model is applied to perform a text-based video generation operation, a text-based video content editing operation, a video enhancement operation, video compression, a data augmentation operation, or a combination thereof. To illustrate, the method 1400 may include receiving an input that indicates to perform the text-based video generation operation, the text-based video content editing operation, the video enhancement operation, the video compression, the data augmentation operation, or a combination thereof. For example, the input may include or correspond to the input data 115. The media data may be generated based on the received input.

In some embodiments, the method 1400 includes storing the media data at a memory. For example, the memory may include or correspond to the memory 106. Additionally, or alternatively, the method may also include outputting the media data to an output device including a display, a speaker, or a combination thereof.

In some embodiments, the method 1400 includes determining a quality indicator associated with the media data. For example, the quality indicator may be determined based on an input (e.g., input data 115). Based on the quality indicator, a set of low-rank adaptation (LoRA) weights can be selected from multiple sets of LoRA weights. The multiple sets of LoRA weights may include or correspond to the parameters 110. The method 1400 may include applying the selected set of LoRA weights to the media generation model for generation of the media data.

The method 1400 may further include training the media generation model. To train the media generation model, the method 1400 may include, for each block of the plurality of blocks of the media generation model, initializing a spatial module of the block, and providing an output of the spatial module to a temporal module via a residual adaptor structure. For example, the spatial module and the temporal module may include or correspond to the spatial module 210 and the temporal module 212, respectively. To train the media generation model, the method 1400 may also include, for each block of the plurality of blocks of the media generation model, providing an output of the temporal module to a gate function. A gate parameter of the gate function is initialized to a first value. For example, the gate parameter and the gate function may include or correspond to the gate parameter θ and the gating function o, respectively.

To train the media generation model, the method 1400 may further include, adapting the gate parameter based on a loss function associated with the media generation model. For example, the loss function may include or correspond to the loss function £. The loss function may include a term based on an average gate parameter value associated with the media generation model. In some embodiments, the method 1400 includes, after adapting the gate parameters of the plurality of blocks, pruning at least one temporal module from the media generation model based on a value of the gate parameter associated with the at least one temporal module.

FIG. 15 is a diagram of an example of a method 1500 of training a media generation model, in accordance with some aspects of the present disclosure. In a particular aspect, one or more operations of the method 1500 are performed by the system 100, the device 102, the processor 108, the video generator 120, or a combination thereof. Additionally, or alternatively, it is noted that the method 1500 may include or correspond to one or more operations of the training technique described with reference to at least FIGS. 2 and 3.

In some embodiments, the method 1500 includes, at block 1502, training a first model. For example, the first model may include or correspond to the untrained media generation model 430. Training the first model includes adapting values of a gate function. For example, the gate function may include or correspond to the gating function o.

The method 1500 also includes, at block 1504, removing, based on a value of the gate function, at least one temporal module from multiple temporal modules of the at least one block to generate a second model. For example, the at least one temporal module may include or correspond to the temporal module 212.

The method 1500 further includes, at block 1506, storing the media generation model at a memory of a media device. For example, the memory may include or correspond to the memory 106. The media generation model may include or correspond to the media generation model 130. The media generation model may be based on the second model.

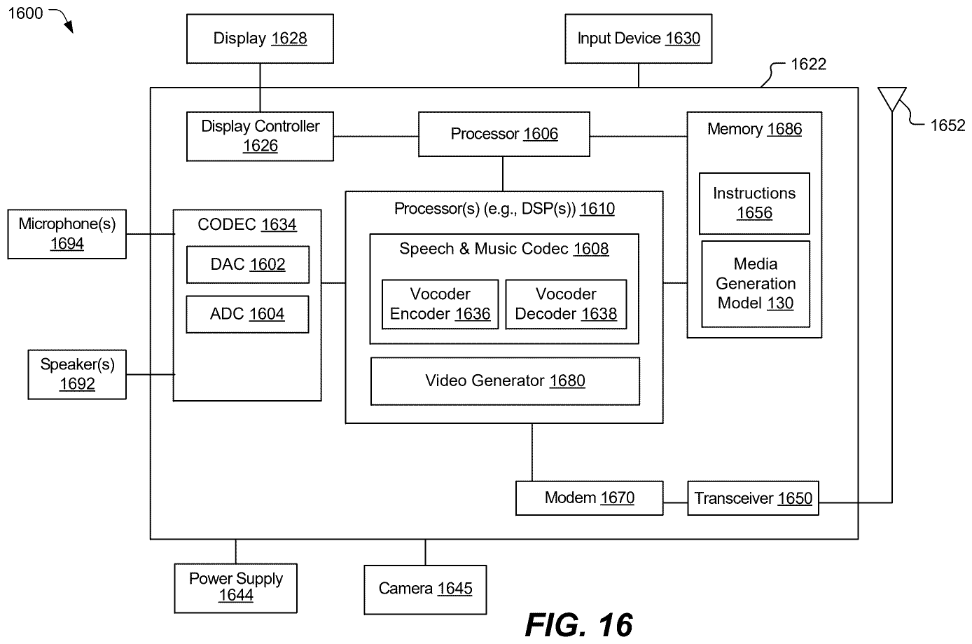

The method 1400 of FIG. 14 or the method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1400 of FIG. 14, the method 1500 of FIG. 15, or a combination thereof, may be performed by a processor that executes instructions, such as described with reference to FIG. 16.

It is noted that one or more blocks (or operations) described with reference to FIG. 14 or 15 may be combined with one or more blocks (or operations) described with reference to another of the figures. For example, one or more blocks (or operations) of FIG. 14 may be combined with one or more blocks (or operations) of FIG. 15. As another example, one or more blocks associated with FIG. 14 or 15 may be combined with one or more blocks (or operations) associated with FIGS. 1-13. Additionally, or alternatively, one or more operations described above with reference to FIGS. 1-15 may be combined with one or more operations described with reference to FIG. 16.

FIG. 16 is a block diagram of an illustrative example of a device 1600 that is operable to generate media data based on a media generation model, in accordance with one or more aspects of the present disclosure. In various implementations, the device 1600 may have more or fewer components than illustrated in FIG. 16. In an illustrative implementation, the device 1600 may correspond to the device 102. In an illustrative implementation, the device 1600 may perform one or more operations described with reference to FIGS. 1-15. Additionally, or alternatively, the device 1600 may include or correspond to the device 102 or to any of the devices of FIGS. 6-13.

In a particular implementation, the device 1600 includes a processor 1606 (e.g., a central processing unit (CPU)). The device 1600 may include one or more additional processors 1610 (e.g., one or more DSPs). In a particular aspect, the processor 108 of FIG. 1 or the processor 508 of FIG. 5 corresponds to the processor 1606, the processors 1610, or a combination thereof. The processors 1610 may include a speech and music coder-decoder (CODEC) 1608 that includes a voice coder (“vocoder”) encoder 1636, a vocoder decoder 1638, or a combination thereof. Additionally, or alternatively, the processors 1610 may include a video generator 1680. The video generator 1680 may include or correspond to the video generator 120 or 520. In some examples, the processor 1606 or 1610 is configured to generate the media generation model 130. To illustrate, the processor 1606 or 1610 is configured to train a first model, such as the untrained media generation model 430, to generate the media generation model 130.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnected sets of transistors and memory elements) that can be configured (often on the fly) to perform customizable logic functions.

The device 1600 may include a memory 1686 and a CODEC 1634. The memory 1686 may include or correspond to the memory 106 or 506. The memory 1686 may include instructions 1656, that are executable by the one or more additional processors 1610 (or the processor 1606) to implement the functionality described with reference to the processor 1606 or 1610, the video generator 1680, or a combination thereof. The instructions 1656 may include or correspond to the instructions 109. The memory 1686 also includes the media generation model 130. The device 1600 may include the modem 1670 coupled, via a transceiver 1650, to an antenna 1652. The modem 1670 may include or correspond to the modem 118.

The device 1600 may include a display 1628 coupled to a display controller 1626. The display 1628 may include or correspond to the display device 116. One or more speakers 1692, the microphone(s) 1694, or a combination thereof, may be coupled to the CODEC 1634. For example, the one or more speakers 1692 and the one or more microphones 1694 may include or correspond to the speaker 117 and the input device 114, respectively. The CODEC 1634 may include a digital-to-analog converter (DAC) 1602, an analog-to-digital converter (ADC) 1604, or both. In a particular implementation, the CODEC 1634 may receive analog signals from the microphone(s) 1694, convert the analog signals to digital signals using the analog-to-digital converter 1604, and provide the digital signals to the speech and music codec 1608. In a particular implementation, the speech and music codec 1608 may provide digital signals to the CODEC 1634. The CODEC 1634 may convert the digital signals to analog signals using the digital-to-analog converter 1602 and may provide the analog signals to the speaker 1692.

In a particular implementation, the device 1600 may be included in a system-in-package or system-on-chip device 1622. For example, the system-in-package or system-on-chip device 1622 may include or correspond to the integrated circuit 502. In a particular implementation, the memory 1686, the processor 1606, the processors 1610, the display controller 1626, the CODEC 1634, and the modem 118 are included in the system-in-package or system-on-chip device 1622. In a particular implementation, an input device 1630, a power supply 1644, and a camera 1645 are coupled to the system-in-package or the system-on-chip device 1622. For example, the input device 1630 and the camera 1645 may include or correspond to the input device 114 and the image sensor 112, respectively. In some examples, the input device 1630 may include or be associated with the display device 116 or the display 1628. Moreover, in a particular implementation, as illustrated in FIG. 16, the display 1628, the input device 1630, the speaker(s) 1692, the microphone(s) 1694, the antenna 1652, the power supply 1644, and the camera 1645 are external to the system-in-package or the system-on-chip device 1622. In a particular implementation, each of the display 1628, the input device 1630, the speaker(s) 1692, the microphone(s) 1694, the antenna 1652, the power supply 1644, and the camera 1645 may be coupled to a component of the system-in-package or the system-on-chip device 1622, such as an interface or a controller.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining a media generation model. For example, the means for obtaining can include the system 100, the device 102, the memory 106, the processor 108, the video generator 120, the integrated circuit 502, the memory 506, the processor 508, the video generator 520, the device 1600, the processor 1606, the processor(s) 1610, the system-in-package or the system-on-chip device 1622, the video generator 1680, the memory 1686, other circuitry configured to obtain the media generation model, or a combination thereof. In some implementations, the media generation model includes a plurality of blocks that each include one or more spatial modules. A first block of the plurality includes a first count of temporal modules. The first count is greater than or equal to one. A second block of the plurality includes a second count of temporal modules that is less than the first count.

The apparatus also includes means for generating, based on the media generation model, media data. For example, the means for generating can include the system 100, the device 012, the processor 108, the video generator 120, the integrated circuit 502, the processor 508, the video generator 520, the device 1600, the processor 1606, the processor(s) 1610, the system-in-package or the system-on-chip device 1622, the video generator 1680, other circuitry configured to generate the media data, or a combination thereof.

In some implementations, a non-transitory computer-readable medium (e.g., a computer-readable storage device, such as the memory 1686) includes instructions (e.g., the instructions 1656) that, when executed by one or more processors (e.g., the one or more processors 1610 or the processor 1606), cause the one or more processors to obtain a media generation model (e.g., the media generation model 130). The media generation model includes a plurality of blocks that each includes one or more spatial modules. A first block of the plurality includes a first count of temporal modules. The first count is greater than or equal to one. A second block of the plurality includes a second count of temporal modules that is less than the first count. The instructions, when executed by the one or more processors, further cause the one or more processors to generate, based on the media generation model, media data.

Particular aspects of the disclosure are described below in sets of interrelated Examples:

According to Example 1, a device includes a memory configured to store media data; and one or more processors configured to obtain a media generation model, where the media generation model includes a plurality of blocks that each include one or more spatial modules; and where: a first block of the plurality of blocks includes a first count of one or more temporal modules, the first count is greater than or equal to one; and a second block of the plurality of blocks includes a second count of temporal modules that is less than the first count; and generate, based on the media generation model, the media data.

Example 2 includes the device of Example 1, where the media generation model includes a video diffusion model, and the media data includes video data.

Example 3 includes the device of Example 1 or Example 2, where the one or more spatial modules include a residual block (resblock) module, a transformer module, or a combination thereof.

Example 4 includes the device of any of Examples 1 to 3, where the one or more temporal modules of the first block include a temporal residual block (resblock) module, a temporal transformer module, or a combination thereof.

Example 5 includes the device of any of Examples 1 to 4, where one or more blocks of the plurality of blocks include a count of zero temporal modules.

Example 6 includes the device of any of Examples 1 to 5, where each block of the plurality of blocks includes the same count of spatial modules.

Example 7 includes the device of any of Examples 1 to 6, where the media generation model has a U-Net architecture including the plurality of blocks.

Example 8 includes the device of any of Examples 1 to 7, where, to train the media generation model, the one or more processors are configured to for each block of the plurality of blocks of the media generation model: initialize a spatial module of the block; provide an output of the spatial module to a temporal module via a residual adaptor structure; and provide an output of the temporal module to a gate function, where a gate parameter of the gate function is initialized to a first value; and adapt the gate parameter based on a loss function associated with the media generation model.

Example 9 includes the device of Example 8, where: the one or more processors are configured to, after adapting gate parameters of the plurality of blocks, prune at least one temporal module from the media generation model based on a value of the gate parameter associated with the at least one temporal module; and the loss function includes a term based on an average gate parameter value associated with the media generation model.

Example 10 includes the device of any of Examples 1 to 9, where the one or more processors are configured to determine a quality indicator associated with the media data; select, based on the quality indicator, a set of low-rank adaptation (LoRA) weights from multiple sets of LoRA weights; and apply the selected set of LORA weights to the media generation model for generation of the media data.

Example 11 includes the device of any of Examples 1 to 10, where the media generation model is applied to perform a text-based video generation operation, a text-based video content editing operation, a video enhancement operation, video compression, a data augmentation operation, or a combination thereof.

Example 12 includes the device of any of Examples 1 to 11, where the device further includes one or more cameras coupled to the one or more processors and configured to generate image data; and an input device configured to receive an input and provide the input to the one or more processors, where the input includes a request to generate the media data based on the image data from the one or more cameras.

Example 13 includes the device of any of Examples 1 to 11, where the device further includes one or more cameras coupled to the one or more processors and configured to generate image data, where the media data is generated by the one or more processors at least partially based on the image data from the one or more cameras.

Example 14 includes the device of any of Examples 1 to 13, where the device further includes a display device coupled to the one or more processors and configured to output the media data, where the media data includes video content.

Example 15 includes the device of any of Examples 1 to 14, where the device further includes a modem coupled to the one or more processors, the modem configured to transmit the media data to a second device for output by the second device.

Example 16 includes the device of any of Examples 1 to 15, where the device further includes a microphone configured to provide an input signal to the one or more processors to cause the one or more processors to generate the media data.

Example 17 includes the device of any of Examples 1 to 16, where the device further includes a speaker configured to output audio associated with the media data.

Example 18 includes the device of any of Examples 1 to 17, where the one or more processors are integrated in at least one of a mobile phone, a tablet computer device, a wearable electronic device, a virtual reality headset, a mixed reality headset, an augmented reality headset, or a camera device.

According to Example 19, a method of operating a media device includes obtaining a media generation model, where the media generation model includes a plurality of blocks that each include one or more spatial modules, and where: a first block of the plurality includes a first count of temporal modules, the first count is greater than or equal to one; and a second block of the plurality includes a second count of temporal modules that is less than the first count; and generating, based on the media generation model, media data.

Example 20 includes the method of Example 19, where the media generation model includes a video diffusion model, and the media data includes video data.

Example 21 includes the method of Example 19 or Example 20, where the one or more spatial modules include a residual block (resblock) module, a transformer module, or a combination thereof.

Example 22 includes the method of any of Examples 19 to 21, where the one or more temporal modules of the first block include a temporal residual block (resblock) module, a temporal transformer module, or a combination thereof.

Example 23 includes the method of any of Examples 19 to 22, where one or more blocks of the plurality of blocks include a count of zero temporal modules.

Example 24 includes the method of any of Examples 19 to 23, where each block of the plurality of blocks includes the same count of spatial modules.

Example 25 includes the method of any of Examples 19 to 24, where the media generation model has a U-Net architecture including the plurality of blocks.

Example 26 includes the method of any of Examples 19 to 25, where, to train the media generation model, the method includes, for each block of the plurality of blocks of the media generation model: initializing a spatial module of the block; providing an output of the spatial module to a temporal module via a residual adaptor structure; and providing an output of the temporal module to a gate function, where a gate parameter of the gate function is initialized to a first value; and adapting the gate parameter based on a loss function associated with the media generation model.

Example 27 includes the method of Example 26, the method further includes, after adapting gate parameters of the plurality of blocks, pruning at least one temporal module from the media generation model based on a value of the gate parameter associated with the at least one temporal module; and where the loss function includes a term based on an average gate parameter value associated with the media generation model.

Example 28 includes the method of any of Examples 19 to 27, the method further includes determining a quality indicator associated with the media data; selecting, based on the quality indicator, a set of LoRA weights from multiple sets of LoRA weights; and applying the selected set of LoRA weights to the media generation model for generation of the media data.

Example 29 includes the method of any of Examples 19 to 28, where the media generation model is applied to perform a text-based video generation operation, a text-based video content editing operation, a video enhancement operation, video compression, a data augmentation operation, or a combination thereof.

Example 30 includes the method of any of Examples 19 to 29, the method further includes generating image data using one or more cameras; and receiving an input from an input device, where the input includes a request to generate the media data based on the image data from the one or more cameras.

Example 31 includes the method of any of Examples 19 to 29, the method further includes generating image data using one or more cameras, where the media data is generated at least partially based on the image data from the one or more cameras.

Example 32 includes the method of any of Examples 19 to 31, the method further includes outputting the media data via a display device, where the media data includes video content.

Example 33 includes the method of any of Examples 19 to 32, the method further includes transmitting, via a modem, the media data to an output device for output by the output device.

Example 34 includes the method of any of Examples 19 to 33, the method further includes receiving an input signal from a microphone, where the input signal indicates to generate the media data.

Example 35 includes the method of any of Examples 19 to 34, the method further includes outputting, via a speaker, output audio associated with the media data.

Example 36 includes the method of any of Examples 19 to 35, where the method is performed by one or more processors integrated in a mobile phone, a tablet computer device, a wearable electronic device, a virtual reality headset, a mixed reality headset, an augmented reality headset, or a camera device.

According to Example 37, a non-transitory computer-readable medium that stores instructions that are executable by one or more processors to cause the one or more processors to obtain a media generation model, where the media generation model includes a plurality of blocks that each include one or more spatial modules; and where: a first block of the plurality includes a first count of temporal modules, the first count is greater than or equal to one; and a second block of the plurality includes a second count of temporal modules that is less than the first count; and generate, based on the media generation model, media data.

Example 38 includes the non-transitory computer-readable medium of Example 37, where the media generation model includes a video diffusion model, and the media data includes video data.

Example 39 includes the non-transitory computer-readable medium of Example 37 or Example 38, where the one or more spatial modules include a resblock module, a transformer module, or a combination thereof.

Example 40 includes the non-transitory computer-readable medium of any of Examples 37 to 39, where the one or more temporal modules of the first block include a temporal resblock module, a temporal transformer module, or a combination thereof.

Example 41 includes the non-transitory computer-readable medium of any of Examples 37 to 40, where one or more blocks of the plurality of blocks include a count of zero temporal modules.

Example 42 includes the non-transitory computer-readable medium of any of Examples 37 to 41, where each block of the plurality of blocks includes the same count of spatial modules.

Example 43 includes the non-transitory computer-readable medium of any of Examples 37 to 42, where the media generation model has a U-Net architecture including the plurality of blocks.

Example 44 includes the non-transitory computer-readable medium of any of Examples 37 to 43, where, to train the media generation model, the instructions further cause the one or more processors to, for each block of the plurality of blocks of the media generation model: initialize a spatial module of the block; provide an output of the spatial module to a temporal module via a residual adaptor structure; and provide an output of the temporal module to a gate function, where a gate parameter of the gate function is initialized to a first value; and adapt the gate parameter based on a loss function associated with the media generation model.

Example 45 includes the non-transitory computer-readable medium of Example 44, where the instructions further cause the one or more processors to, after adapting gate parameters of the plurality of blocks, prune at least one temporal module from the media generation model based on a value of the gate parameter associated with the at least one temporal module; and where the loss function includes a term based on an average gate parameter value associated with the media generation model.

Example 46 includes the non-transitory computer-readable medium of any of Examples 37 to 45, where the instructions further cause the one or more processors to determine a quality indicator associated with the media data; select, based on the quality indicator, a set of LoRA weights from multiple sets of LoRA weights; and apply the selected set of LoRA weights to the media generation model for generation of the media data.

Example 47 includes the non-transitory computer-readable medium of any of Examples 37 to 46, where the media generation model is applied to perform a text-based video generation operation, a text-based video content editing operation, a video enhancement operation, video compression, a data augmentation operation, or a combination thereof.

Example 48 includes the non-transitory computer-readable medium of any of Examples 37 to 47, where the instructions further cause the one or more processors to receive image data generated by one or more cameras; and receive, from an input device, an input that includes a request to generate the media data based on the image data from the one or more cameras.

Example 49 includes the non-transitory computer-readable medium of any of Examples 37 to 47, where the instructions further cause the one or more processors to receive image data generated by one or more cameras, where the media data is generated at least partially based on the image data from the one or more cameras.

Example 50 includes the non-transitory computer-readable medium of any of Examples 37 to 49, where the instructions further cause the one or more processors to output, via a display device, the media data, and where the media data includes video content.

Example 51 includes the non-transitory computer-readable medium of any of Examples 37 to 50, where the instructions further cause the one or more processors to transmit, via a modem, the media data to an output device for output by the output device.

Example 52 includes the non-transitory computer-readable medium of any of Examples 37 to 51, where the instructions further cause the one or more processors to receive, from a microphone, an input signal that indicates to generate the media data.

Example 53 includes the non-transitory computer-readable medium of any of Examples 37 to 52, where the instructions further cause the one or more processors to output, via a speaker, audio associated with the media data.

Example 54 includes the non-transitory computer-readable medium of any of Examples 37 to 53, where the one or more processors are integrated in at least one of a mobile phone, a tablet computer device, a wearable electronic device, a virtual reality headset, a mixed reality headset, an augmented reality headset, or a camera device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store media data; and
one or more processors configured to:
obtain a media generation model, wherein the media generation model includes a plurality of blocks that each include one or more spatial modules; and wherein:
a first block of the plurality of blocks includes a first count of one or more temporal modules, the first count is greater than or equal to one; and
a second block of the plurality of blocks includes a second count of temporal modules that is less than the first count; and
generate, based on the media generation model, the media data.

2. The device of claim 1, wherein the media generation model includes a video diffusion model, and the media data includes video data.

3. The device of claim 1, wherein the one or more spatial modules include a residual block (resblock) module, a transformer module, or a combination thereof.

4. The device of claim 1, wherein the one or more temporal modules of the first block include a temporal residual block (resblock) module, a temporal transformer module, or a combination thereof.

5. The device of claim 1, wherein one or more blocks of the plurality of blocks include a count of zero temporal modules.

6. The device of claim 1, wherein each block of the plurality of blocks includes the same count of spatial modules.

7. The device of claim 1, wherein the media generation model has a U-Net architecture including the plurality of blocks.

8. The device of claim 1, wherein, to train the media generation model, the one or more processors are configured to:
for each block of the plurality of blocks of the media generation model:
initialize a spatial module of the block;
provide an output of the spatial module to a temporal module via a residual adaptor structure; and
provide an output of the temporal module to a gate function, wherein a gate parameter of the gate function is initialized to a first value; and
adapt the gate parameter based on a loss function associated with the media generation model.

9. The device of claim 8, wherein:
the one or more processors are configured to, after adapting gate parameters of the plurality of blocks, prune at least one temporal module from the media generation model based on a value of the gate parameter associated with the at least one temporal module; and
the loss function includes a term based on an average gate parameter value associated with the media generation model.

10. The device of claim 1, wherein the one or more processors are configured to:
determine a quality indicator associated with the media data;
select, based on the quality indicator, a set of low-rank adaptation (LoRA) weights from multiple sets of LoRA weights; and
apply the selected set of LoRA weights to the media generation model for generation of the media data.

11. The device of claim 1, wherein the media generation model is applied to perform a text-based video generation operation, a text-based video content editing operation, a video enhancement operation, video compression, a data augmentation operation, or a combination thereof.

12. The device of claim 1, further comprising:
one or more cameras coupled to the one or more processors and configured to generate image data; and
an input device configured to receive an input and provide the input to the one or more processors, wherein the input includes a request to generate the media data based on the image data from the one or more cameras.

13. The device of claim 1, further comprising:
one or more cameras coupled to the one or more processors and configured to generate image data, wherein the media data is generated by the one or more processors at least partially based on the image data from the one or more cameras.

14. The device of claim 1, further comprising:
a display device coupled to the one or more processors and configured to output the media data, wherein the media data includes video content.

15. The device of claim 1, further comprising a modem coupled to the one or more processors, the modem configured to transmit the media data to a second device for output by the second device.

16. The device of claim 1, further comprising:
a microphone configured to provide an input signal to the one or more processors to cause the one or more processors to generate the media data.

17. The device of claim 1, further comprising:
a speaker configured to output audio associated with the media data.

18. The device of claim 1, wherein the one or more processors are integrated in at least one of a mobile phone, a tablet computer device, a wearable electronic device, a virtual reality headset, a mixed reality headset, an augmented reality headset, or a camera device.

19. A method of operating a media device including a processor, the method comprising:
obtaining a media generation model, wherein the media generation model includes a plurality of blocks that each include one or more spatial modules, and wherein:
a first block of the plurality includes a first count of temporal modules, the first count is greater than or equal to one; and
a second block of the plurality includes a second count of temporal modules that is less than the first count; and
generating, based on the media generation model, media data.

20. A non-transitory computer-readable medium that stores instructions that are executable by one or more processors to cause the one or more processors to:
obtain a media generation model, wherein the media generation model includes a plurality of blocks that each include one or more spatial modules; and wherein:
a first block of the plurality includes a first count of temporal modules, the first count is greater than or equal to one; and
a second block of the plurality includes a second count of temporal modules that is less than the first count; and
generate, based on the media generation model, media data.
